(19) United States
(12) Patent Application Publication
(10) Pub. No.: US 2022/0018661 A1
(43) Pub. Date: Jan. 20, 2022

(54) Target Localization Using AC Magnetic Fields

(71) Applicant: Apple Inc., Cupertino, CA (US)

(72) Inventors: Sheng Liu, San Jose, CA (US); Jian Guo, Milpitas, CA (US)

(21) Appl. No.: 16/931,416

(22) Filed: Jul. 16, 2020

(51) Int. Cl. G01C 21/20; H04W 4/024; H04W 4/02; G01C 21/08

(52) U.S. Cl. CPC G01C 21/206; G01C 21/08; H04W 4/023; H04W 4/024

(57) ABSTRACT

A device operates in pairing mode, indoor navigation mode or search mode. For each mode, a magnetic sensor in the device senses one or more alternating current (AC) magnetic fields emitted by one or more transmitters in a three-dimensional (3D) space, and uses the one or more AC magnetic fields to determine a position of the device relative to the one or more transmitters or another device. In pairing mode, relative position vectors computed from two or more AC magnetic fields allows the device to choose the closest transmitter for pairing. In indoor navigation mode, multiple detections of AC magnetic fields emitted by multiple transmitters assist a user in navigating an indoor space. In search mode, a companion device and a lost device each sense an AC magnetic field from a transmitter, and the AC magnetic fields are used to determine a relative position vector from the companion device to the lost device.

### TECHNICAL FIELD

This disclosure relates generally to target localization using AC magnetic fields.

### BACKGROUND

Magnetic tracking systems are used to track the position of a moving target, such as a medical instrument manipulated by a robotic arm. Existing magnetic tracking systems include a fixed transmitter (e.g., a base station) that generates alternating or static magnetic fields that cover a three-dimensional (3D) space. The transmitter typically includes a three-axis coil comprising three separate coils that are arranged perpendicular to each other and are configured to transmit magnetic fields in three dimensions. The target also includes a 3-axis coil or magnetometer that senses a change in the magnetic fields generated by the transmitter as the target moves in the 3D space. A processor on the target computes the position of the target (referred to as “localization”) in the 3D space based on the change in the magnetic fields.

### SUMMARY

Embodiments are disclosed for target localization applications using alternating current (AC) magnetic fields. A device is configured to operate in one of a pairing mode, indoor navigation mode or search mode. For each mode, a magnetic sensor in the device senses one or more AC magnetic fields emitted by one or more transmitters in a 3D space, and uses the one or more AC magnetic fields to determine a position of the device relative to the one or more transmitters or another device.

In an embodiment, a method comprises: configuring a device operating in 3D space into a pairing mode, the pairing mode causing: a magnetic field sensor in the device to sense a first AC magnetic field emitted by a first transmitter located in the 3D space at a first frequency, and to sense a second AC magnetic field emitted by a second transmitter located in the 3D space at a second frequency that is different than the first frequency; the one or more processors of the device to determine a first position of the device relative to the first transmitter location based at least in part on the sensed first AC magnetic field; the one or more processors to determine a second position of the device relative to the second transmitter location based at least in part on the sensed second AC magnetic field; the one or more processors to select one of the first or second transmitters for pairing with the device based on a comparison of the first and second positions; and the one or more processors to initiate pairing with the selected transmitter.

In an embodiment, a method comprises: configuring a device operating in 3D indoor space into a guidance mode for navigating a route in the indoor space, the guidance mode causing: one or more processors of the device to generate a route in the indoor space; a magnetic field sensor in the device to sense a first AC magnetic field emitted by a first transmitter at a first location on the route, the first transmitter emitting the first AC magnetic field at a first frequency; the one or more processors of the device to determine the first location of the first transmitter on the route based at least in part on the sensed first AC magnetic field; the one or more processors to generate first guidance instructions to the first location; the magnetic field sensor in the device to sense a second AC magnetic field emitted by a second transmitter at a second location on the route in the 3D space, the second transmitter emitting the second AC magnetic field at a second frequency that is different than the first frequency; the one or more processors of the device to determine the second location of the second transmitter on the route based at least in part on the sensed second AC magnetic field; and the one or more processors to generate second guidance instructions to the second location.

In an embodiment, a method comprises: configuring a first device operating in a 3D indoor space into a search mode, the search mode causing: a first magnetic field sensor in the first device to sense an AC magnetic field emitted by a transmitter at a transmitter location in the 3D space; the first processor of the first device to determine a first relative position vector from a first device location to the transmitter location, the first relative position vector determined based at least in part on the sensed AC magnetic field and the first device location; a first wireless transceiver of the first device to send the first position to a network computer; a second magnetic field sensor in the second device to sense the AC magnetic field emitted by the transmitter; the second processor of the second device to determine a second relative position vector from a second device location to the transmitter location, the second relative position vector determined based at least in part on the sensed AC magnetic field and the second device location; a second wireless transceiver of the second device to send the second relative position vector to the network computer; the first wireless transceiver to receive, from the network computer, the second relative position vector; the first processor to compute a third relative position vector from the first device location to the second device location based on the first relative position vector and the second relative position vector; and presenting, using a display of the first device, a location of the second device based at least in part on the third relative position vector.

Other embodiments can include an apparatus, computing device, system and non-transitory, computer-readable storage medium.

Particular embodiments disclosed herein provide one or more of the following advantages. One or more coils on transmitters installed at fixed locations (e.g., speakers, wireless chargers) are configured to generate AC magnetic fields in 3D space that are sensed by devices (e.g., smartphones, wearable devices, tablet computers) in the 3D space. The devices use a magnetic field sensor (e.g., a 3-axis magnetometer) to sense changes in the AC magnetic fields generated by the transmitters. Because existing coils and sensors are used for transmission and sensing of magnetic fields in 3D space, respectively, no new hardware is required for either the transmitter or the device. Additionally, the disclosed embodiments have lower power consumption to minimize the impact on battery life of the device as opposed to other technologies, such as ultrawide band (UWB) technology. Low power consumption can benefit applications with high sample rates, real-time applications and “always on” applications. Additionally, the disclosed embodiments provide advantages in device pairing, indoor navigation and applications for finding lost or stolen devices.

The details of one or more implementations of the subject matter are set forth in the accompanying drawings and the description below. Other features, aspects and advantages of the subject matter will become apparent from the description, the drawings and the claims.

### BRIEF DESCRIPTION OF THE DRAWINGS

FIG. 1 illustrates a magnetic field positioning system, according to an embodiment.

FIG. 2 is a top plan view of a physical floor plan for a device pairing application that uses the magnetic field positioning system of FIG. 1, according to an embodiment.

FIG. 3 is a top plan view of a virtual floor plan for the device pairing application that uses the magnetic field positioning system of FIG. 1, according to an embodiment.

FIG. 4 is a top plan view of an indoor space illustrating the use of the magnetic positioning system of FIG. 1 in an indoor navigation application, according to an embodiment.

FIG. 5 illustrates the use of the magnetic field positioning system of FIG. 1 with a single transmitter in an application that finds lost devices, according to an embodiment.

FIG. 6 illustrates the use of the magnetic field positioning system of FIG. 1 with multiple transmitters in an application that finds lost devices, according to an embodiment.

FIG. 7 is a flow diagram of a process that uses magnetic field positioning in a device pairing application, according to an embodiment.

FIG. 8 is a flow diagram of a process that uses magnetic field positioning in an indoor navigation application, according to an embodiment.

FIG. 9 is a flow diagram of a process that uses magnetic field positioning in a an application for finding lost or stolen devices, according to an embodiment.

FIG. 10 is example device/transmitter architecture that includes the features and performs the processes as described in reference to FIGS. 1-9.

### DETAILED DESCRIPTION

### Example Magnetic Field Positioning System

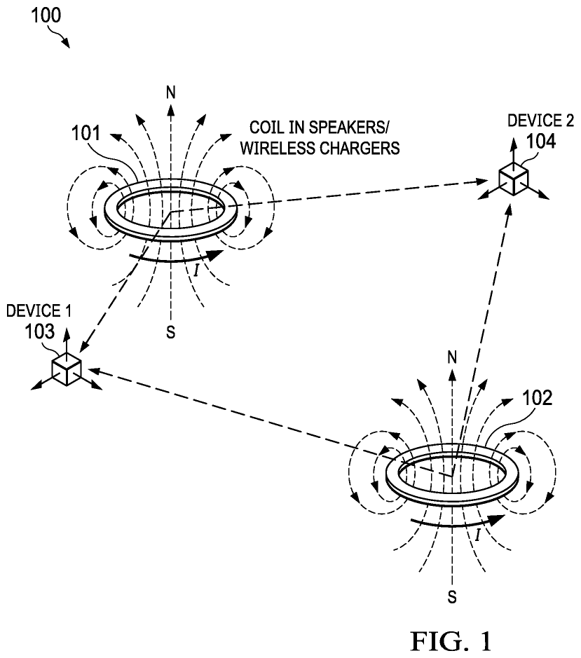

FIG. 1 illustrates a magnetic field positioning system 100, according to an embodiment. System 100 includes transmitter 101, transmitter 102, device 103 and device 104. Transmitters 101, 102 are configured to emit alternating current (AC) magnetic fields. The AC magnetic fields can be generated using for example single axis or multi-axis coils. Transmitters 101, 102 can be, any device capable of transmitting an AC magnetic field, including but not limited to loudspeakers, wireless chargers and the like. Devices 103, 104 can be any device capable of sensing an AC magnetic field. For example, smart phones, tablet computers and smart watches, typically include a 3-axis magnetometer for sensing magnetic fields.

With a certain geometry of the coils, the magnetic field \vec{B}(r) profile is fixed and can be modeled as a magnetic dipole. The 3-axis magnetometers can detect and demodulate the magnetic field vector \vec{B}(r) into x, y, z coordinates, and hence determine device position relative to the field source (relative to the transmitter coil). An AC magnetic field (as opposed to a DC magnetic field) provides several advantages for device positioning. The AC magnetic field is emitted at a frequency that is above the human audible frequency range (>20 kHz). The AC magnetic field allows for an increased signal-to-noise ratio (SNR) to maximize operation range. The AC magnetic field allows multiple AC magnetic field sources to be distinguished from each other by emitting at unique operating frequencies. The AC magnetic field enables potential encoding of simple information with signal modulation (e.g., for device privacy/security).

In an embodiment, a dipole model (distance>>coil diameter) described by Equation [1] is used to derive a system of non-linear sense field Equations [2]:

$$\vec{B} ( r ) = ∇ xA = \frac{{μ}_{o}}{4 π} ( \frac{3 \vec{r} ( \vec{M} \cdot \vec{r} )}{{r}^{5}} - \frac{\vec{M}}{{r}^{3}} ) , \qquad [ 1 ]$$

where μₒ is permeability of vacuum, and M=IA, where I is coil current and A is coil area,

$${B}_{x} = \frac{K}{{( {x}^{2} + {y}^{2} + {z}^{2} )}^{\frac{5}{2}}} [ 3 x ( {M}_{x} x + {M}_{y} y + {M}_{z} z ) - {M}_{x} ( {x}^{2} + {y}^{2} + {z}^{2} ) ] , \\ {B}_{y} = \frac{K}{{( {x}^{2} + {y}^{2} + {z}^{2} )}^{\frac{5}{2}}} [ 3 y ( {M}_{x} x + {M}_{y} y + {M}_{z} z ) - {M}_{y} ( {x}^{2} + {y}^{2} + {z}^{2} ) ] , \\ {B}_{z} = \frac{K}{{( {x}^{2} + {y}^{2} + {z}^{2} )}^{\frac{5}{2}}} [ 3 z ( {M}_{x} x + {M}_{y} y + {M}_{z} z ) - {M}_{z} ( {x}^{2} + {y}^{2} + {z}^{2} ) ] . \qquad [ 2 ]$$

The system of non-linear Equations [2] is solved for sensor position (x, y, z) using any suitable non-linear solver. In an embodiment, the sensor position (x, y, z) is determined using the Simplex method and the updated sensor position is determined using Newton's method or similar derivative-based methods, or any other suitable non-linear equation solver.

An advantage of system 100 compared to other magnetic tracking systems is that system 100 leverages existing hardware (coils, magnetometers) on transmitters 101, 102 and devices 103, 104, so that no additional hardware is needed for device positioning applications. Based on the application, certain firmware/software updates may be needed to accommodate coil drivers (source) and magnetometers (sensing).

### Example Device Pairing Application

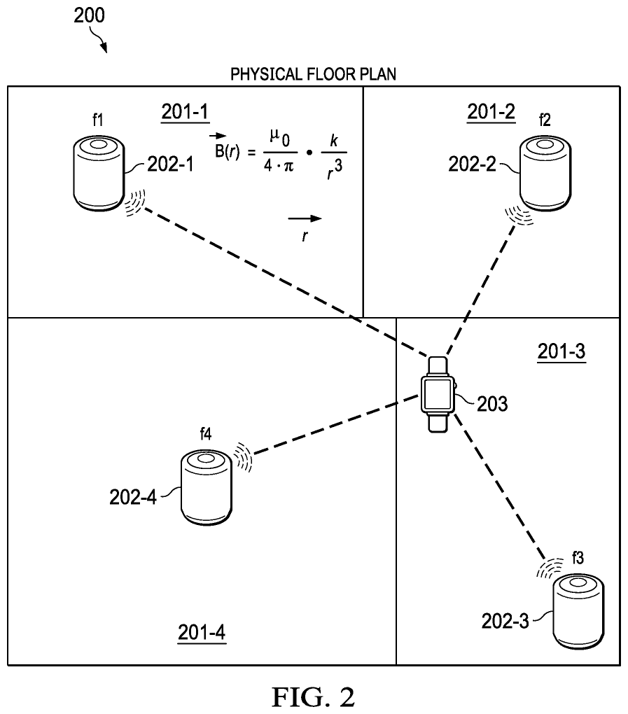

FIG. 2 is a top plan view of a physical floor plan 200 for a device pairing application that uses the magnetic field positioning system of FIG. 1, according to an embodiment. Floor plan 200 includes spaces 201-1 to 201-4. Space 201-1 includes transmitter 202-1, space 201-2 includes transmitter 202-2, space 201-3 includes transmitter 202-3 and space 201-4 includes transmitter 202-4. In the example shown, the transmitters 202-1 to 202-4 are speakers. FIG. 2 also shows device 203 (e.g., a smart watch) located in space 201-3.

In this example scenario, it is desired to get a better user experience when pairing (e.g., Bluetooth pairing) device 203 with one of speakers 202-1 to 202-4, especially if pairing is initiated by the user through a digital assistant by a voice command. If speakers 202-1 to 202-4 are each within pairing distance of device 203 but in different rooms of a home, for example, the wrong speaker may be paired with device 203. For example, space 201-3 may be the user's bedroom and the user desires to pair with speaker 202-3. The user speaks a voice command to pair device 203 with speaker 202-3. However, device 203 instead pairs with speaker 202-2 in space 201-2, such as the user's living room. This is due to the difficulty of using a sound waves to determine the speaker that is closest to device 203.

In this example scenario, AC magnetic fields generated by speakers 202-1 to 202-4 can be used to provide more accurate position information to device 203. For example, during Bluetooth pairing, each speaker 202-1 to 202-4 generates an AC magnetic field using their one or more coils. The AC magnetic fields are generated at unique frequencies. Device 203 identifies each speaker by its transmission frequency and estimates a distance to each speaker based on the AC magnetic field emitted by the speaker. For example, a 3-axis magnetometer in device 203 senses each AC magnetic field and computes a relative position vector [x, y, z] to each speaker using, for example, Equation [2] or other suitable model. Since each AC magnetic field is transmitted at a unique frequency, the AC magnetic fields can be distinguished by device 203. Based on the estimated distances, device 203 can determine the speaker that is closest to device 203 and then automatically pair with that speaker.

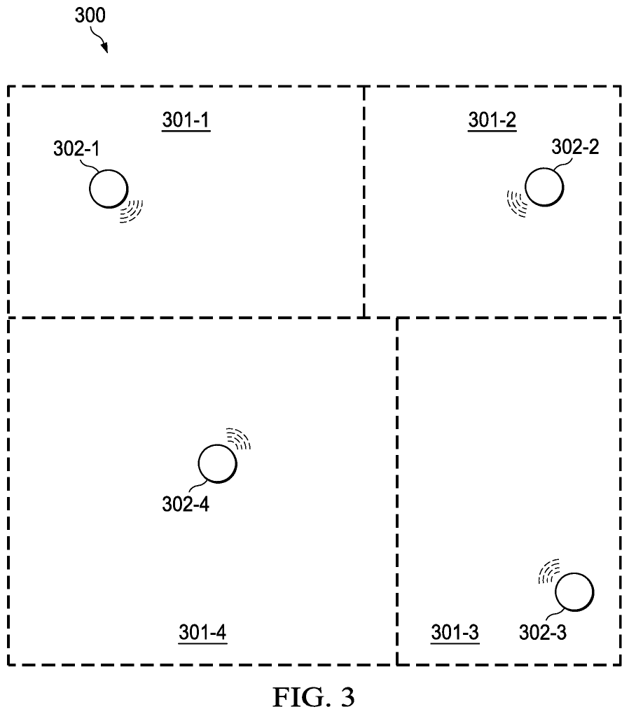

FIG. 3 is a top plan view of a virtual floor plan 300 for the device pairing application that uses the magnetic field positioning system of FIG. 1, according to an embodiment. Virtual floor plan 300 includes virtual speakers 302-1 to 302-4, located in spaces 301-1 to 301-4, respectively. In embodiment, a depth sensor (e.g., a LiDAR) scan is used to generate a virtual floor plan 300 from physical floor plan 200 shown in FIG. 2. Virtual floor plan 300 can be customized to specific applications, such as, for example, augmented reality (AR) or virtual reality (VR) applications by combining AC magnetic field readings with a LiDAR scan. For example, the pairing application described above can be improved by recognizing the distance or proximity to each speaker and the user location in the different spaces without scanning the spaces optically every time the pairing application is used. With AR/VR capabilities (e.g., a LiDAR scanner), device 203 can create virtual floor plan 300 by scanning the space with the depth sensor and recording the sensed AC magnetic fields (e.g., using a 3-axis magnetometer) emitted by the transmitters at the same time. The information from both sensors can be fused to create virtual floor plan 300 with speakers 302-1 to 302-4 (e.g., recognized by a camera of device 203) as a reference point in each space 301-1 to 301-4.

### Indoor Navigation

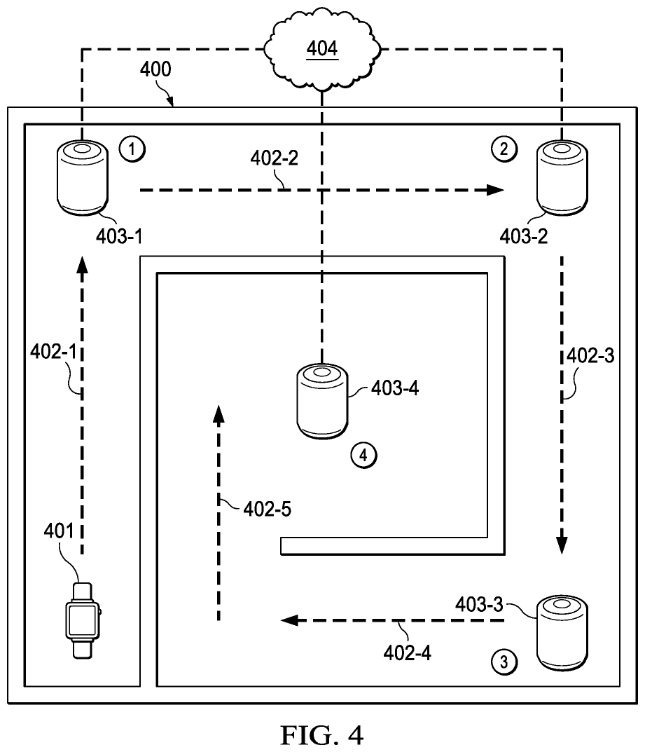

FIG. 4 is a top plan view of an indoor space illustrating the use of the magnetic positioning system of FIG. 1 in an indoor navigation application, according to an embodiment. Outdoor positioning can be accomplished with a Global Navigation Satellite System (GNSS) receiver, such as Global Positioning System (GPS), or WiFi positioning or other beacon sources (e.g., Bluetooth low energy beacons (BTLE)). However, indoor navigation can be challenging due to the complexity of indoor three-dimensional (3D) structures (e.g., the floor difference) and the inability to receive GNSS signals in most cases. However, sequential position guidance can be provided by device 401 using magnetic field transmitters fixed in indoor space 400.

Referring to FIG. 4, indoor space 400 includes device 401 (e.g., a smart watch) traveling an indoor route that includes 5 route segments 402-1 to 402-5, where each route segment is indicated by a dashed arrow. The user wearing/holding device 401 desires to navigate to the center of indoor space 400. There are four transmitters 403-1 to 403-4 located along the route as shown. Each transmitter can be commanded by network computer 404 to command transmitters 403-1 to 403-4 to emit AC magnetic fields. Each transmitter 403-1 to 403-4 emits an AC magnetic field with a unique frequency, so that the magnetic fields can be distinguished by device 401.

More particularly, when a user starts an indoor navigation application on device 401, a command is sent from device 401 to network computer 404. In response to the command, network computer 404 sends activation commands to transmitters 403-1 to 403-4. In response to the activation commands, each transmitter emits an AC magnetic field with a unique frequency. When a first AC magnetic field emitted by transmitter 403-1 is sensed by device 401, a first set of guidance instructions to second transmitter 403-2 are generated by the indoor navigation application to guide the user from first transmitter 403-1 to second transmitter 403-2. In an embodiment, the guidance instructions include turn-by-turn instructions and are presented on a display of device 401. The display can show, for example, the position of device 401 and the positions of each transmitter 403-1 to 403-4 on a digital map of indoor space 400. In other embodiments, audio guidance is provided by an audio subsystem of device 401 that outputs spoken guidance instructions together with the displayed instructions or in lieu of the displayed instructions.

The first guidance instructions guide the user along route segment 402-2 to the location of second transmitter 403-2. When device 401 detects a second AC magnetic field emitted from second transmitter 403-2, a second set of guidance instructions are generated by the application to guide the user along route segment 402-3 to third transmitter 403-3. When device 401 detects a third magnetic field emitted by third transmitter 403-3, the application generates a third set of guidance instructions to guide the user along route segments 402-4 and 402-5 to fourth transmitter 403-4. By using the transmitters as waypoints for receiving guidance instructs for the next segment of the route, the user is guided to the final destination.

In an embodiment, other low cost transmitters (e.g., BTLE beacons) can be deployed in indoor space 400 to increase signal strength and navigation accuracy. In an embodiment, the location of each transmitter is encoded in the indoor navigation application software so the correct sequence of transmissions can be emitted by the transmitters based on the user's transient location.

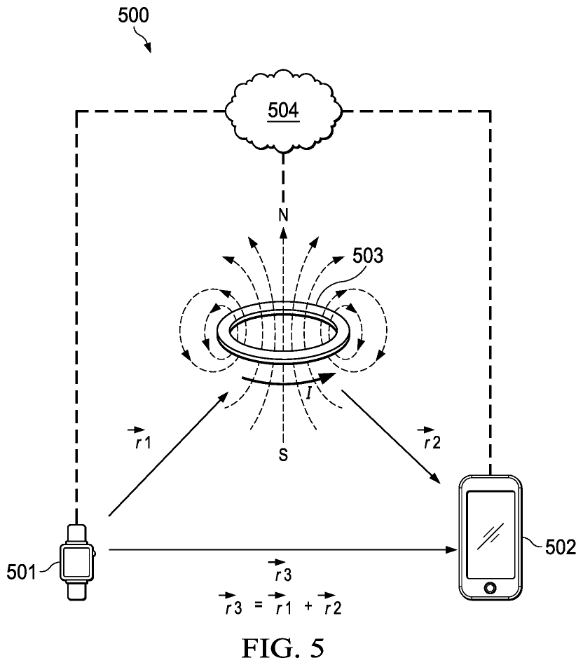

FIG. 5 illustrates the use of the magnetic field positioning system of FIG. 1 with a single transmitter in an application that finds lost devices, according to an embodiment. Some existing applications for finding lost devices rely on sound emitted by the lost device for position tracking, which can be disrupted, in audible or difficult to determine directions to the lost device. For example, the sound beacon emitted by the lost device can be attenuated by ambient noise or occluded by objects (e.g., the device is under a blanket or inside a drawer) in the space. Additionally, the space may not allow a certain sound level, such as during a conference, in a movie theatre or during sleeping hours at home. Also, long distance tracking can be an issue when the lost device cannot receive a sound beacon command signal sent by a companion device running the search application.

### Searching for Local Lost Devices

Referring to FIG. 5, companion device 501 (e.g., a smart watch) is used to find lost device 502 (e.g., a smart phone). Transmitter 503 is within magnetic communication distance of devices 501, 502, such that magnetometers on devices 501 and 502 can sense an AC magnetic field emitted by transmitter 503. Transmitter 503 is also in communication with network 504. Device 501 uses the sensed AC magnetic field to compute a first relative position vector \vec{r}1 from device 501 to transmitter 503. Similarly, device 502 uses the sensed AC magnetic field emitted by transmitter 503 to compute a second relative position vector \vec{r}2 from transmitter 503 to device 502. The second relative position vector \vec{r}2 can be sent to device 501 through network 504. A search application running on device 501 can then compute a third relative position vector \vec{r}3 from the location of device 501 to the location of device 502 using simple vector addition (\vec{r}3=\vec{r}1+\vec{r}2). With the relative position \vec{r}3 known, a compass direction to lost device 502 is computed in the local reference frame of devices 501 and 502. The compass direction can be presented on a display of companion device 501 and/or spoken using an audio subsystem of companion device 501.

### Searching for Lost Devices Using Multiple Transmitters

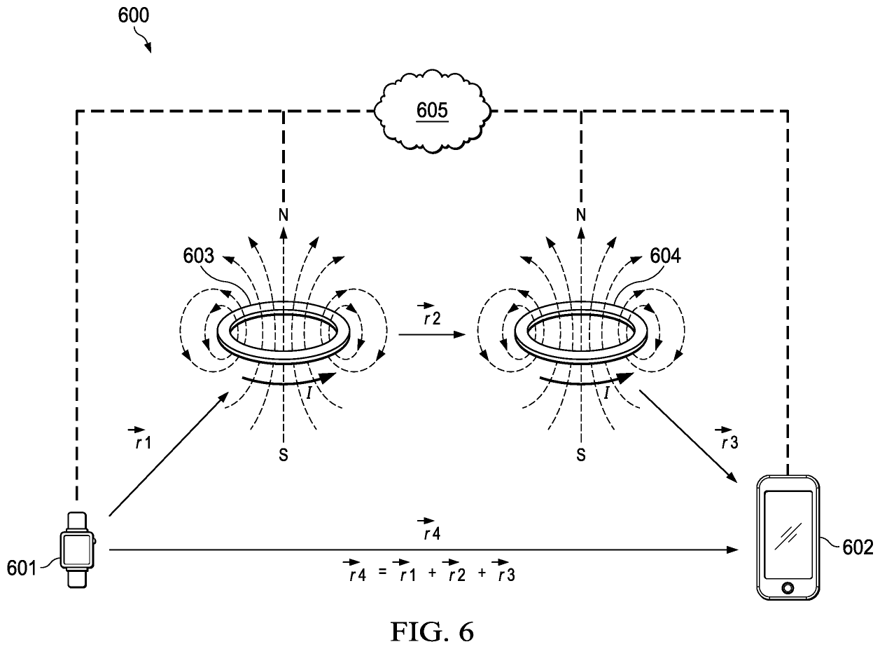

FIG. 6 illustrates the use of the magnetic field positioning system 600 1 with multiple transmitters in an application that finds lost devices, according to an embodiment. When two devices are far enough apart so that the magnetic field from one transmitter cannot be detected by both the companion device and the lost device, a second transmitter in the space of the lost device can be activated using a network computer. To determine a rough location of the lost device and which transmitter to activate in the space of the lost device, GNSS information or a WiFi database can be used. With the relative position between the two transmitters known (e.g., using pre-calibration performed by a user during an initial set-up of the transmitter), the relative position vector from the first transmitter to the second transmitter can be computed.

Referring to FIG. 6, companion device 601 senses a first AC magnetic field emitted by first transmitter 603 within magnetic field detection distance of companion device 601, and computes a first relative position vector \vec{r}1 from device 601 to first transmitter 603. First transmitter 603 can be selected and activated by network 605 based on, for example, GPS data provided by a GPS receiver of companion device 601, or if indoors, a location using WiFi or location beacons. The magnetic field detection distance depends on the device and the amount of transmit power available on companion device 601, and is the maximum distance where the AC magnetic field can be detected by the magnetometer of companion device 601.

At a different location, lost device 602 senses a second AC magnetic field emitted by a second transmitter 604 within magnetic field detection distance of lost device 602, and computes a second relative position vector \vec{r}3 from the location of second transmitter 604 to the location of lost device 602. Second transmitter 604 can be selected and activated by network 605 based on, for example, GNSS data and/or WiFi and/or location beacons. The magnetic field detection distance depends on the device and the amount of transmit power available on lost device 602. The second relative position vector \vec{r}3 can be sent to network 605, which then sends the second relative position vector \vec{r}3 to companion device 601. Additionally, GNSS data and/or WiFi and/or location beacons can provide respective geographic locations for transmitters 603 and 602. These locations can be sent by network 605 to companion device 601.

In an embodiment, GNSS data for transmitters 603, 604 are obtained from GNSS receivers embedded in transmitters 603, 604. In an embodiment, the user provides the locations of the transmitters 603, 604 to network computer 605 using a suitable graphical user interface (GUI). In an embodiment, the geographic locations of companion device 601 and lost device 602 can be used as proxies for the geographic locations of transmitters 603, 604.

A search application running on companion device 601 computes a third relative position vector \vec{r}2 from the location of first transmitter 603 to the location of second transmitter 604. Using the first, second and third relative position vectors, companion device computes a fourth relative position vector \vec{r}4 from the location of companion device 601 to lost device 602 using vector addition (\vec{r}4=\vec{r}1+\vec{r}2+\vec{r}3). The fourth relative position vector \vec{r}4 is used to generate a compass direction to lost device 602 in a local reference frame. The compass direction can be presented on a display of companion device 601 and/or spoken using an audio subsystem of companion device 601.

In the examples above, the companion device computes the final relative position vector. In other embodiments, network computer and/or transmitter can compute the relative position vector and provide it to the companion device.

### Example Processes

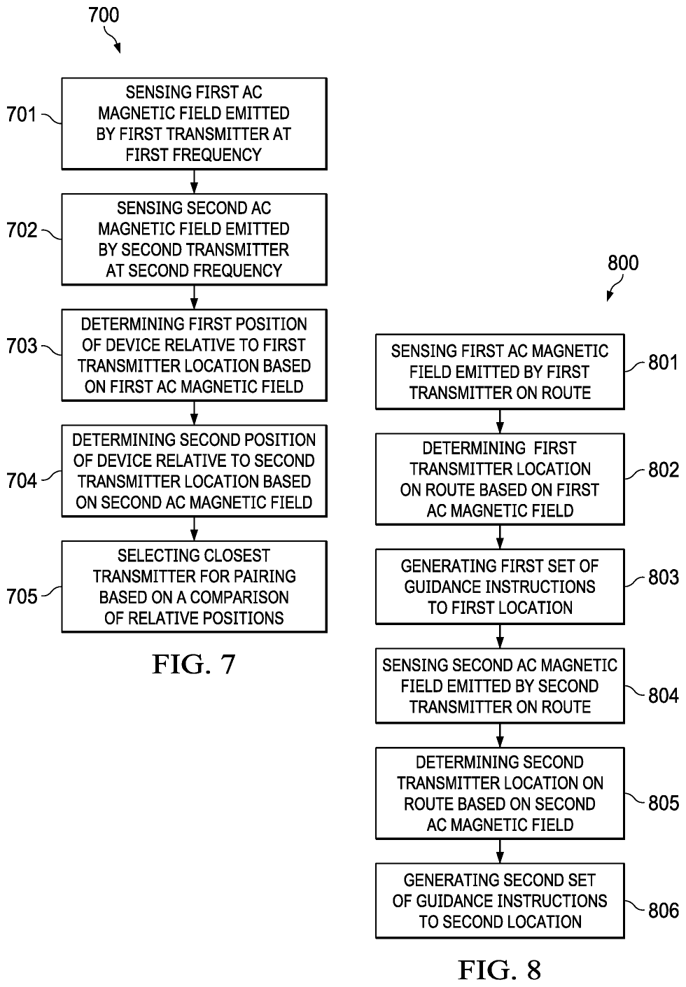

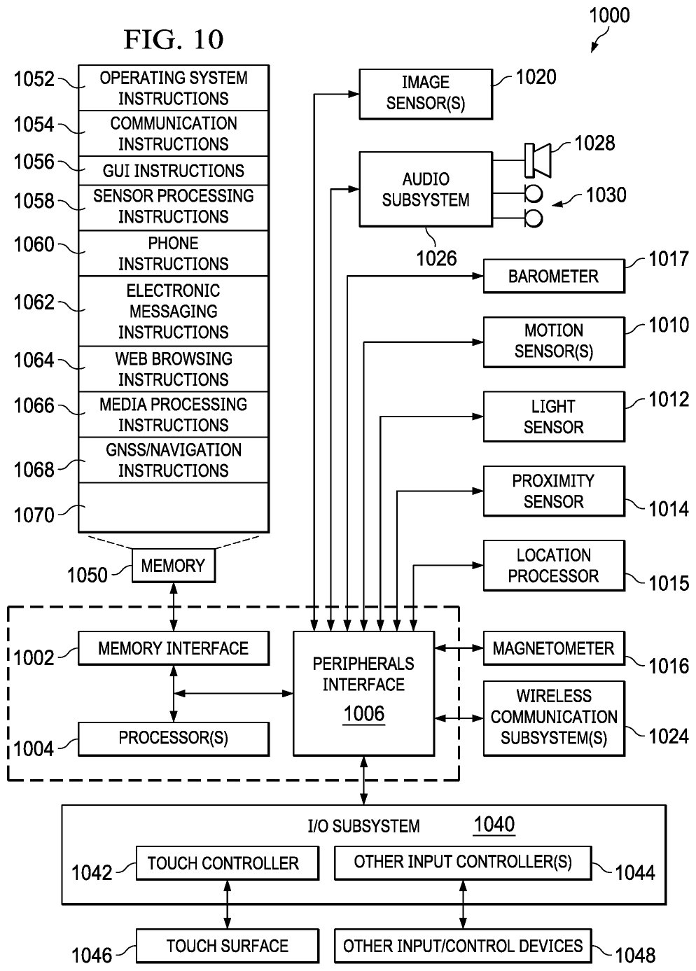

FIG. 7 is a flow diagram of a process 700 that uses magnetic field positioning in a device pairing application, according to an embodiment. Process 700 can be implemented using, for example, the device architecture 1000, as described in reference to FIG. 10.

Process 700 includes sensing a first AC magnetic field emitted by a first transmitter at a first frequency (701), sensing a second AC magnetic field emitted by a second transmitter at a second frequency (702), determining a first position of a device relative to the first transmitter location based on the first AC magnetic field (703), determining a second position of the device relative to a second transmitter location based on the second AC magnetic field (704), and selecting one of the first or second transmitters for pairing based on a comparison of the transmitter positions (705). The foregoing steps are described in more detail, in reference to FIGS. 1-3.

FIG. 8 is a flow diagram of a process 800 that uses magnetic field positioning in an indoor navigation application, according to an embodiment. Process 800 can be implemented using, for example, the device architecture 1000, as described in reference to FIG. 10.

Process 800 includes sensing a first AC magnetic field emitted by a first transmitter (801), determining a first transmitter location on the route based on the first AC magnetic field (802), generating a first set of guidance instructions to the first transmitter location (803), sensing a second AC magnetic field emitted by a second transmitter (804), determining a second transmitter location on the route based on the second AC magnetic field (805) and generating a second set of guidance instructions to the second transmitter location (806). The foregoing steps are described in more detail, in reference to FIGS. 1 and 4.

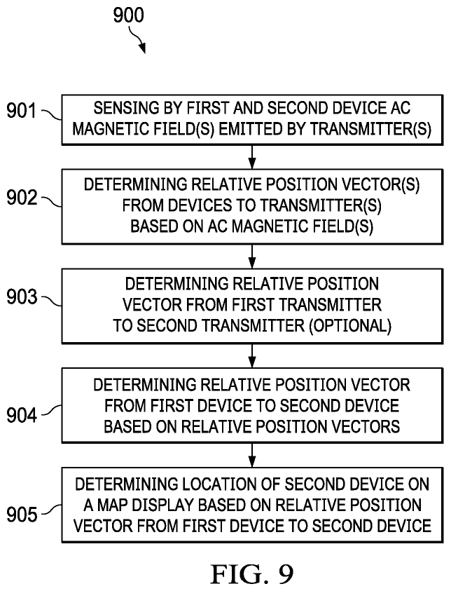

FIG. 9 is a flow diagram of a process 900 that uses magnetic field positioning in a an application for finding lost or stolen devices, according to an embodiment. Process 900 can be implemented using, for example, the device architecture 1000, as described in reference to FIG. 10.

Process 900 includes sensing by a first and second device AC magnetic fields emitted by one or more transmitters (901), determining positions of first and second devices relative to the one or more transmitters based on the AC magnetic fields (902), optionally determining the position of a first transmitter relative to a second transmitter (903), determining the position of the first device relative to the second device based on the position vectors (904) and determining the location of the second device in a map display based on the position of the first device relative to the second device (905). The foregoing steps are described in more detail, in reference to FIGS. 5 and 6.

### Example Mobile Device Architecture

FIG. 10 illustrates example device/transmitter architecture 1000 implementing the features and operations described in reference to FIGS. 1-9. Architecture 1000 can include memory interface 1002, one or more data processors, digital signal processors (DSPs), image processors and/or central processing units (CPUs) 1004 and peripherals interface 1006. Memory interface 1002, one or more processors 1004 and/or peripherals interface 1006 can be separate components or can be integrated in one or more integrated circuits.

Sensors, devices and subsystems can be coupled to peripherals interface 1006 to provide multiple functionalities. For example, one or more motion sensors 1010, light sensor 1012 and proximity sensor 1014 can be coupled to peripherals interface 1006 to facilitate motion sensing (e.g., acceleration, rotation rates), lighting and proximity functions of the wearable computer. Location processor 1015 can be connected to peripherals interface 1006 to provide geo-positioning. In some implementations, location processor 1015 can be a GNSS receiver, such as the Global Positioning System (GPS) receiver. Electronic magnetometer 1016 (e.g., an integrated circuit chip) can also be connected to peripherals interface 1006 to provide data that can be used to determine the direction of magnetic North. Electronic magnetometer 1016 provide data to an electronic compass application, and is also used to sense AC magnetic fields emitted by transmitters, as described in reference to FIGS. 1-9. Motion sensor(s) 1010 can include one or more accelerometers and/or gyros configured to determine change of speed and direction of movement of the wearable computer. Barometer 1017 can be configured to measure atmospheric pressure around the mobile device. Image sensors 1020 include one or more cameras and depth sensor to capture video and depth data for use in various applications. In an embodiment, a haptic engine (not shown) provides force feedback and can include a linear resonant actuator (LRA).

Communication functions can be facilitated through wireless communication subsystems 1024, which can include radio frequency (RF) receivers and transmitters (or transceivers) and/or optical (e.g., infrared) receivers and transmitters. The specific design and implementation of the communication subsystem 1024 can depend on the communication network(s) over which a mobile device is intended to operate. For example, architecture 1000 can include communication subsystems 1024 designed to operate over a GSM network, a GPRS network, an EDGE network, a Wi-Fi™ network and a Bluetooth™ network. In particular, the wireless communication subsystems 1024 can include hosting protocols, such that the mobile device can be configured as a base station for other wireless devices.

Audio subsystem 1026 can be coupled to a speaker 1028 and one or more microphones 1030 to facilitate voice-enabled functions, such as voice recognition, voice replication, digital recording and telephony functions. Audio subsystem 1026 can be configured to receive voice commands from the user.

I/O subsystem 1040 can include touch surface controller 1042 and/or other input controller(s) 1044. Touch surface controller 1042 can be coupled to a touch surface 1046. Touch surface 1046 and touch surface controller 1042 can, for example, detect contact and movement or break thereof using any of a plurality of touch sensitivity technologies, including but not limited to capacitive, resistive, infrared and surface acoustic wave technologies, as well as other proximity sensor arrays or other elements for determining one or more points of contact with touch surface 1046. Touch surface 1046 can include, for example, a touch screen or the digital crown of a smart watch. I/O subsystem 1040 can include a haptic engine or device for providing haptic feedback (e.g., vibration) in response to commands from processor 1004. In an embodiment, touch surface 1046 can be a pressure-sensitive surface.

Other input controller(s) 1044 can be coupled to other input/control devices 1048, such as one or more buttons, rocker switches, thumb-wheel, infrared port and USB port The one or more buttons (not shown) can include an up/down button for volume control of speaker 1028 and/or microphone 1030. Touch surface 1046 or other controllers 1044 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 1046; and a pressing of the button for a second duration that is longer than the first duration may turn power to the mobile device on or off. The user may be able to customize a functionality of one or more of the buttons. The touch surface 1046 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 1002 can be coupled to memory 1050. Memory 1050 can include high-speed random access memory and/or non-volatile memory, such as one or more magnetic disk storage devices, one or more optical storage devices and/or flash memory (e.g., NAND, NOR). Memory 1050 can store operating system 1052, such as the iOS operating system developed by Apple Inc. of Cupertino, Calif. Operating system 1052 may include instructions for handling basic system services and for performing hardware dependent tasks. In some implementations, operating system 1052 can include a kernel (e.g., UNIX kernel).

Memory 1050 may also store communication instructions 1054 to facilitate communicating with one or more additional devices, one or more computers and/or one or more servers, such as, for example, instructions for implementing a software stack for wired or wireless communications with other devices. Memory 1050 may include graphical user interface instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic-messaging related processes and functions; web browsing instructions 1064 to facilitate web browsing-related processes and functions; media processing instructions 1066 to facilitate media processing-related processes and functions; GNSS/Location instructions 1068 to facilitate generic GNSS and location-related processes and instructions; and instructions 1070 for performing the device positioning applications described in reference to FIG. 3.

Each of the above identified instructions and applications can correspond to a set of instructions for performing one or more functions described above. These instructions need not be implemented as separate software programs, procedures, or modules. Memory 1050 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., SWIFT, Objective-C, C #, Java), including compiled or interpreted languages, and it can be deployed in any form, including as a stand-alone program or as a module, component, subroutine, a browser-based web application, or other unit suitable for use in a computing environment.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A method comprising:
configuring a device operating in a three-dimensional (3D) space into a pairing mode, the pairing mode causing:
a magnetic field sensor in the device to sense a first alternating current (AC) magnetic field emitted by a first transmitter located in the 3D space at a first frequency, and to sense a second AC magnetic field emitted by a second transmitter located in the 3D space at a second frequency that is different than the first frequency;
the one or more processors of the device to determine a first position of the device relative to the first transmitter location based at least in part on the sensed first AC magnetic field;
the one or more processors to determine a second position of the device relative to the second transmitter location based at least in part on the sensed second AC magnetic field;
the one or more processors to select one of the first or second transmitters for pairing with the device based on a comparison of the first and second positions; and
the one or more processors to initiate pairing with the selected transmitter.

2. The method of claim 1, wherein upon successful pairing with the selected transmitter, the device is configured into an application mode, the application mode causing the magnetic field sensor to sense a third magnetic field.

3. The method of claim 2, wherein the magnetic field sensor is a magnetometer and the third magnetic field is a geomagnetic field.

4. The method of claim 1, further comprising:
obtaining, using the wireless transceiver, a floor plan of the 3D space;
determining, using a location processor, a current location of the device in the 3D space;
generating, using the one or more processors, a floor plan showing locations of the first and second transmitters and the device in the floor plan; and
presenting, using the one or more processors, the floor plan on a display of the device.

5. The method of claim 4, further comprising:
obtaining, using the one or more processors, user input selecting one of the first or second transmitter for pairing; and
initiating, using the wireless transceiver, pairing with the user-selected transmitter.

6. The method of claim 1, further comprising:
obtaining, using a sensor of the device, at least one of an image or 3D depth data;
determining, using a location processor, a current location of the device in the 3D space;
generating, using the one or more processors, a virtual floor plan using the image or 3D depth data, the virtual floor plan showing locations of the first and second transmitters and the device in the floor plan; and
presenting, using the one or more processors, the virtual floor plan on a display of the device.

7. The method of claim 6, further comprising:
obtaining, using the one or more processors, user input selecting one of the first or second transmitter for pairing; and
initiating, using the wireless transceiver, pairing with the user-selected transmitter.

8. A method comprising:
configuring a device operating in a three-dimensional (3D) indoor space into a guidance mode for navigating a route in the indoor space, the guidance mode causing:
one or more processors of the device to generate a route in the indoor space;
a magnetic field sensor in the device to sense a first alternating current (AC) magnetic field emitted by a first transmitter at a first location on the route, the first transmitter emitting the first AC magnetic field at a first frequency;
the one or more processors of the device to determine the first location of the first transmitter on the route based at least in part on the sensed first AC magnetic field;
the one or more processors to generate first guidance instructions to the first location;
the magnetic field sensor in the device to sense a second alternating current (AC) magnetic field emitted by a second transmitter at a second location on the route in the 3D space, the second transmitter emitting the second AC magnetic field at a second frequency that is different than the first frequency;
the one or more processors of the device to determine the second location of the second transmitter on the route based at least in part on the sensed second AC magnetic field; and
the one or more processors to generate second guidance instructions to the second location.

9. The method of claim 8, wherein upon completion of the guidance mode, the device is configured into an application mode, the application mode causing the magnetic field sensor to sense a third magnetic field.

10. The method of claim 9, wherein the magnetic field sensor is a magnetometer and the third magnetic field is a geomagnetic field.

11. A method comprising:
configuring a first device operating in a three-dimensional (3D) indoor space into a search mode, the search mode causing:
a first magnetic field sensor in the first device to sense an alternating current (AC) magnetic field emitted by a transmitter at a transmitter location in the 3D space;
the first processor of the first device to determine a first relative position vector from a first device location to the transmitter location, the first relative position vector determined based at least in part on the sensed AC magnetic field and the first device location;
a first wireless transceiver of the first device to send the first position to a network computer;
a second magnetic field sensor in the second device to sense the AC magnetic field emitted by the transmitter;
the second processor of the second device to determine a second relative position vector from a second device location to the transmitter location, the second relative position vector determined based at least in part on the sensed AC magnetic field and the second device location;
a second wireless transceiver of the second device to send the second relative position vector to the network computer;
the first wireless transceiver to receive, from the network computer, the second relative position vector;
the first processor to compute a third relative position vector from the first device location to the second device location based on the first relative position vector and the second relative position vector; and
presenting, using a display of the first device, a location of the second device based at least in part on the third relative position vector.

12. The method of claim 11, wherein presenting a location of the second device based at least in part on the third relative position vector further comprises:
presenting, using the display of the first device, a map of the 3D space with a marker indicating the second device location; and
presenting, using at least the display of the first device or an audio subsystem of the first device, directions to the second device location from the first device location.

13. A method comprising:
configuring a first device operating in a three-dimensional (3D) indoor space into a search mode, the search mode causing:
a first magnetic field sensor in the first device to sense a first alternating current (AC) magnetic field emitted by a first transmitter at a first transmitter location in the 3D space;
the first processor of the first device to determine a first relative position vector from a first device location to the first transmitter location, the first relative position vector determined based at least in part on the sensed first AC magnetic field and the first device location;
a first wireless transceiver of the first device to send the first device position and the first relative position vector to a network computer;
a second magnetic field sensor in the second device to sense a second AC magnetic field emitted by a second transmitter at a second transmitter location in the 3D space;
the second processor of the second device to determine a second relative position vector from a second device location to the second transmitter location, the second relative position vector determined based at least in part on the sensed second AC magnetic field and the second device location;
a second wireless transceiver of the second device to send the second device location and the second relative position vector to the network computer;
the first wireless transceiver to receive, from the network computer, the second relative position vector and a third relative position vector from the first transmitter location to the second transmitter location;
the first processor to compute a fourth relative position vector from the first device location to the second device location based on the first relative position vector, the second relative position vector and the third relative position vector; and
presenting, using a display of the first device, a location of the second device based at least in part on the fourth relative position vector.

14. The method of claim 13, wherein presenting a location of the second device based at least in part on the fourth relative position vector further comprises:
presenting, using the display of the first device, a map of the 3D space with a marker indicating the second device location; and
presenting, using at least the display of the first device or an audio subsystem of the first device, directions to the second device location from the first device location.

15. An apparatus comprising:
a magnetic field sensor;
one or more processors configured to:
initiate a pairing mode;
determine a first position of the apparatus relative to a first transmitter location based at least in part on a first AC magnetic field sensed by the magnetic field sensor;
determine a second position of the apparatus relative to a second transmitter location based at least in part on a second AC magnetic field sensed by the magnetic field sensor;
select one of the first or second transmitters for pairing with the apparatus based on a comparison of the first and second positions; and
initiate pairing with the selected transmitter.

16. The apparatus of claim 15, wherein upon successful pairing with the selected transmitter, the apparatus is configured into an application mode, the application mode causing the magnetic field sensor to sense a third magnetic field.

17. The apparatus of claim 16, wherein the magnetic field sensor is a magnetometer and the third magnetic field is a geomagnetic field.

18. The apparatus of claim 15, further comprising:
a display;
a wireless transceiver;
a location processor;
wherein the one or more processors are further configured to:
obtain, using the wireless transceiver, a floor plan of a three-dimensional (3D) space in which the apparatus is operating;
determine, using the location processor, a current location of the apparatus in the 3D space;
generate, using the one or more processors, a floor plan showing locations of the first and second transmitters and the apparatus in the floor plan; and
present, using the one or more processors, the floor plan on the display of the display.

19. The apparatus of claim 18, further comprising:
obtaining, using the one or more processors, user input selecting one of the first or second transmitters for pairing; and
initiating, using the wireless transceiver, pairing with the user-selected transmitter.

20. The apparatus of claim 16, further comprising:
a sensor;
wherein the one or more processors are further configured to:
obtain, using the sensor, at least one of an image or 3D depth data;
determine, using the location processor, a current location of the apparatus in the 3D space;
generating, using the one or more processors, a virtual floor plan using the image or 3D depth data, the virtual floor plan showing locations of the first and second transmitters and the apparatus in the floor plan; and
presenting, using the one or more processors, the virtual floor plan on the display of the device.

21. The apparatus of claim 20, further comprising:
obtaining, using the one or more processors, user input selecting one of the first or second transmitter for pairing; and
initiating, using the wireless transceiver, pairing with the user-selected transmitter.

22. An apparatus comprising:
a magnetic field sensor;
one or more processors configured to:
initiate a guidance mode for navigating a route in an the indoor space;
generate a route in the indoor space;
determine a first location of a first transmitter on the route based at least in part on a first AC magnetic field sensed by the magnetic field sensor;
generate first guidance instructions to the first location;
determine a second location of a second transmitter on the route based at least in part on a second AC magnetic field sensed by the magnetic sensor; and
generate second guidance instructions to the second location.

23. The apparatus of claim 22, wherein upon completion of the guidance mode, the apparatus is configured into an application mode, the application mode causing the magnetic field sensor to sense a third magnetic field.

24. The apparatus of claim 23, wherein the magnetic field sensor is a magnetometer and the third magnetic field is a geomagnetic field.

25. A system comprising:
a first device comprising:
a first magnetic field sensor;
a first wireless transceiver;
a first processor configured to:
initiate a search mode;
determine a first relative position vector from a first device location to a transmitter location, the first relative position vector determined based at least in part on a sensed AC magnetic field and the first device location;
send the first position to a network computer;
receive, from the network computer, a second relative position vector;
compute a third relative position vector from the first device location to a second device location based on the first relative position vector and the second relative position vector;
present, using a display of the first device, a location of the second device based at least in part on the third relative position vector;
a second device comprising:
a second magnetic field sensor;
a second wireless transceiver
a second processor configured to:
determine the second relative position vector from the second device location to the transmitter location, the second relative position vector determined based at least in part on the sensed AC magnetic field and the second device location; and
send the second relative position vector to the network computer.

26. The apparatus of claim 25, wherein presenting a location of the second device based at least in part on the third relative position vector further comprises:
presenting, using the display of the first device, a map of the 3D space with a marker indicating the second device location; and
presenting, using at least the display of the first device or an audio subsystem of the first device, directions to the second device location from the first device location.

27. An apparatus comprising:
a first device comprising:
a display;
a first magnetic field sensor;
a first wireless transceiver;
a first processor configured to:
initiate a search mode;
determine a first relative position vector from a first device location to a first transmitter location, the first relative position vector determined based at least in part on the a first AC magnetic field and the first device location;
send, using the first wireless transceiver, the first device position and the first relative position vector to a network computer;
receive, from the network computer, a second relative position vector from the second device location to a second transmitter location and a third relative position vector from the first transmitter location to the second transmitter location;
compute a fourth relative position vector from the first device location to the second device location based on the first relative position vector, the second relative position vector and the third relative position vector; and
present, using the display, the second device location based at least in part on the fourth relative position vector.
a second device comprising:
a second magnetic field sensor;
a second wireless transceiver
a second processor configured to:
determine the second relative position vector, the second relative position vector determined based at least in part on a second AC magnetic field and the second device location; and
send, using the second wireless transceiver, the second device location and the second relative position vector to the network computer.

28. The apparatus of claim 27, wherein presenting a location of the second device based at least in part on the fourth relative position vector further comprises:
presenting, using the display of the first device, a map of the 3D space with a marker indicating the second device location; and
presenting, using at least the display of the first device or an audio subsystem of the first device, directions to the second device location from the first device location.
